(19) United States
(12) Patent Application Publication
(10) Pub. No.: US 2017/0117612 A1
(43) Pub. Date: Apr. 27, 2017

(54) ANTENNA, ARRAY ANTENNA, AND RADIO COMMUNICATION APPARATUS

(71) Applicant: NEC Corporation, Tokyo (JP)

(72) Inventors: Hiroshi TOYAO, Tokyo (JP); Keishi KOSAKA, Tokyo (JP)

(73) Assignee: NEC Corporation, Tokyo (JP)

(21) Appl. No.: 15/129,519

(22) PCT Filed: Mar. 17, 2015
(86) PCT No.: PCT/JP2015/001473

§ 371 Date: Sep. 27, 2016

(30) Foreign Application Priority Data
Mar. 31, 2014 (JP) 2014-073196

(51) Int. Cl. H01Q 1/24; H01Q 9/26; H01Q 1/38; H01Q 15/14

(52) U.S. Cl. CPC H01Q 1/24; H01Q 15/14; H01Q 9/265; H01Q 1/38

(57) ABSTRACT

An antenna according to one exemplary aspect of the present invention includes an antenna element and a reflector conductor that is arranged to be spaced apart from the antenna element. The antenna element includes a first split-ring conductor having such a shape that a part of a ring is cut by a split part, a first connection conductor having one end that is electrically connected to the first split-ring conductor and another end that is electrically connected to the reflector conductor, and a feed line conductor having one end that is electrically connected to the first split-ring conductor. The feed line conductor spans an opening that is formed inside the first split-ring conductor and overlaps an area surrounded by an outer edge of the first connection conductor.

### TECHNICAL FIELD

The present invention relates to an antenna, an array antenna, and a radio communication apparatus.

### BACKGROUND ART

In order to deal with a recent sharp increase in an amount of radio communication, use of a Multi Input Multi Output (MIMO) communication system in which a plurality of antennas are concurrently used, beam forming by an array antenna in which a plurality of antennas are arranged and the like has been advancing and the number of antennas mounted on a radio communication apparatus has tended to increase. It is therefore strongly required that both a decrease in the size of the antenna mounted on the radio communication apparatus and a reduction in the cost of the antenna be achieved.

A dipole antenna which has high radiation efficiency and is capable of radiating radio waves in a wide range of directions and a patch antenna that can be formed to be thin are well known as two of the most common antennas. However, it is difficult to reduce the respective sizes of these antennas since they each need to have a size of a half of the wavelength in principle.

Patent Literature 1 discloses a technique for reducing the size of an antenna by adding a parasitic element, a part of which is formed of magnetic materials, to a dipole antenna. In Patent Literature 1, by controlling the distribution of magnetic field lines in the vicinity of the antenna using magnetic materials, it is possible to reduce the size of the antenna and perform impedance matching without using a matching circuit.

Further, Non-Patent Literature 1 discloses a technique for arranging multiple artificial magnetic elements called split-ring resonators inside a patch antenna. By increasing the effective permeability inside the patch antenna by the split-ring resonators, it is possible to shorten the wavelength and to reduce the size of the antenna.

### CITATION LIST

### Patent Literature

[Patent Literature 1] Japanese Unexamined Patent Application Publication No. 2006-222873

### Non Patent Literature

[Non-Patent Literature 1] “Patch Antenna With Stacked Split-Ring Resonators As An Artificial Magneto-Dielectric Substrate,” Microwave and Optical Technology Letters, Vol. 46, No. 6, Sep. 20, 2005

### SUMMARY OF INVENTION

### Technical Problem

However, the antenna disclosed in Patent Literature 1 requires relatively expensive magnetic materials, which increases the cost for manufacturing the antenna.

Further, while the size of the antenna disclosed in Non-Patent Literature 1 can be reduced without using special materials, since the loss of each of the multiple split-ring resonators arranged inside the antenna cannot be negligible in the vicinity of an operating frequency (resonance frequency) of the antenna, the radiation efficiency of the whole antenna is reduced.

The present invention has been made in view of the aforementioned circumstances. One exemplary object of the present invention is to provide an antenna that can be manufactured at a low cost without using special materials and is small, yet still capable of having an excellent antenna performance (high radiation efficiency), an array antenna in which this antenna is arranged, and a radio communication apparatus including the antenna.

### Solution to Problem

An antenna according to one exemplary aspect of the present invention includes:

an antenna element; and

a reflector conductor that is arranged to be spaced apart from an antenna element, in which:

the antenna element comprises:
a first split-ring conductor having such a shape that a part of a ring is cut by a split part;
a first connection conductor having one end that is electrically connected to the first split-ring conductor and another end that is electrically connected to the reflector conductor; and
a feed line conductor having one end that is electrically connected to the first split-ring conductor, and

the feed line conductor spans an opening that is formed inside the first split-ring conductor and overlaps an area surrounded by an outer edge of the first connection conductor.

### Advantageous Effects of Invention

According to the present invention, it is possible to provide an antenna that can be manufactured at a low cost without using special materials and is small, yet still capable of having an excellent antenna performance (high radiation efficiency), an array antenna in which this antenna is arranged, and a radio communication apparatus including the antenna.

### BRIEF DESCRIPTION OF DRAWINGS

FIG. 1 is a perspective view of an antenna according to a first exemplary embodiment;

FIG. 2 is a plan view of the antenna shown in FIG. 1 when it is seen from a y-axis negative direction;

FIG. 3 is a plan view of the antenna shown in FIG. 1 when it is seen from an x-axis negative direction;

FIG. 4 is a plan view of the antenna shown in FIG. 1 when it is seen from a y-axis positive direction;

FIG. 5 is a schematic view of another antenna according to the first exemplary embodiment;

FIG. 6 is a schematic view of another antenna according to the first exemplary embodiment;

FIG. 7 is a schematic view of another antenna according to the first exemplary embodiment;

FIG. 8 is a schematic view of another antenna according to the first exemplary embodiment;

FIG. 9 is a schematic view of another antenna according to the first exemplary embodiment;

FIG. 10 is a diagram for describing the shape of a split part;

FIG. 11 is a diagram showing a part around a split-ring part in which conductive radiation parts are provided;

FIG. 12 is a diagram showing a part around the split-ring part in which another conductive radiation parts are provided;

FIG. 13 is a diagram showing a part around the split-ring part in which another conductive radiation parts are provided;

FIG. 14 is a diagram showing a part around the split-ring part in which another conductive radiation parts are provided;

FIG. 15 is a diagram showing a part around another split-ring part in which the conductive radiation parts are provided;

FIG. 16 is a schematic view of another antenna according to the first exemplary embodiment;

FIG. 17 is a schematic view of another antenna according to the first exemplary embodiment;

FIG. 18 is a diagram showing a configuration example of a radio communication apparatus including the antenna according to the first exemplary embodiment;

FIG. 19 is a perspective view of an antenna according to a second exemplary embodiment;

FIG. 20 is a plan view of the antenna shown in FIG. 19 when it is seen from a y-axis positive direction;

FIG. 21 is a schematic view of an antenna element according to a third exemplary embodiment;

FIG. 22 is a schematic view of another antenna element according to the third exemplary embodiment;

FIG. 23 is a schematic view of another antenna element according to the third exemplary embodiment;

FIG. 24 is a schematic view of an antenna element according to a fourth exemplary embodiment;

FIG. 25 is a schematic view of another antenna element according to the fourth exemplary embodiment;

FIG. 26 is a schematic view of another antenna element according to the fourth exemplary embodiment;

FIG. 27 is a perspective view of an antenna according to a fifth exemplary embodiment;

FIG. 28 is another perspective view of the antenna according to the fifth exemplary embodiment;

FIG. 29 is a perspective view of another antenna according to the fifth exemplary embodiment;

FIG. 30 is a perspective view of another antenna according to the fifth exemplary embodiment;

FIG. 31 is a perspective view of an array antenna according to a sixth exemplary embodiment;

FIG. 32 is a perspective view of another array antenna according to the sixth exemplary embodiment;

FIG. 33 is a perspective view of another array antenna according to the sixth exemplary embodiment; and

FIG. 34 is a perspective view of another array antenna according to the sixth exemplary embodiment.

### DESCRIPTION OF EMBODIMENTS

Hereinafter, with reference to the drawings, exemplary embodiments of the present invention will be described. Throughout the drawings, the same and similar components are denoted by the same reference symbols and overlapping descriptions will be omitted.

### First Exemplary Embodiment

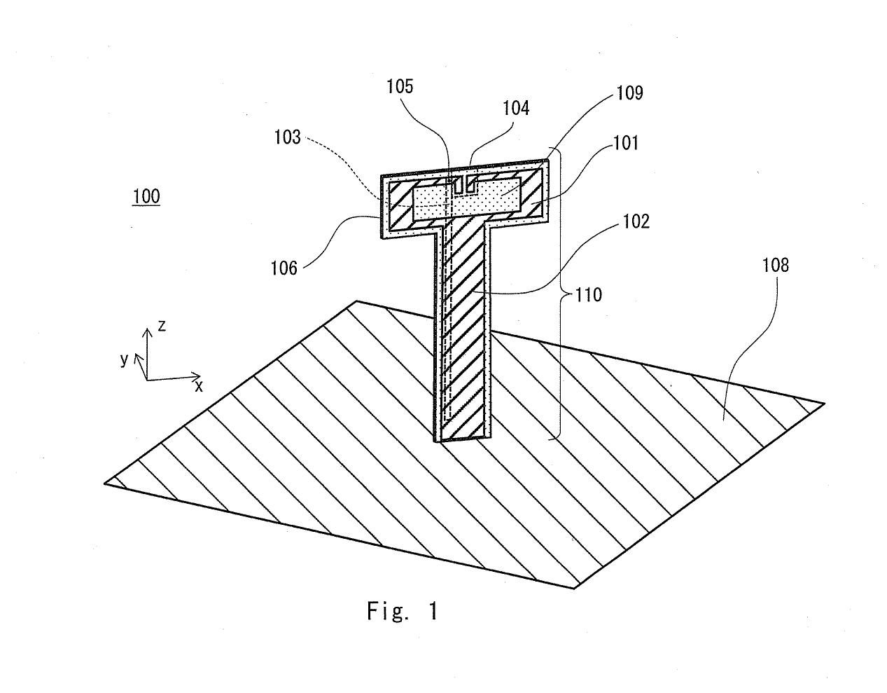

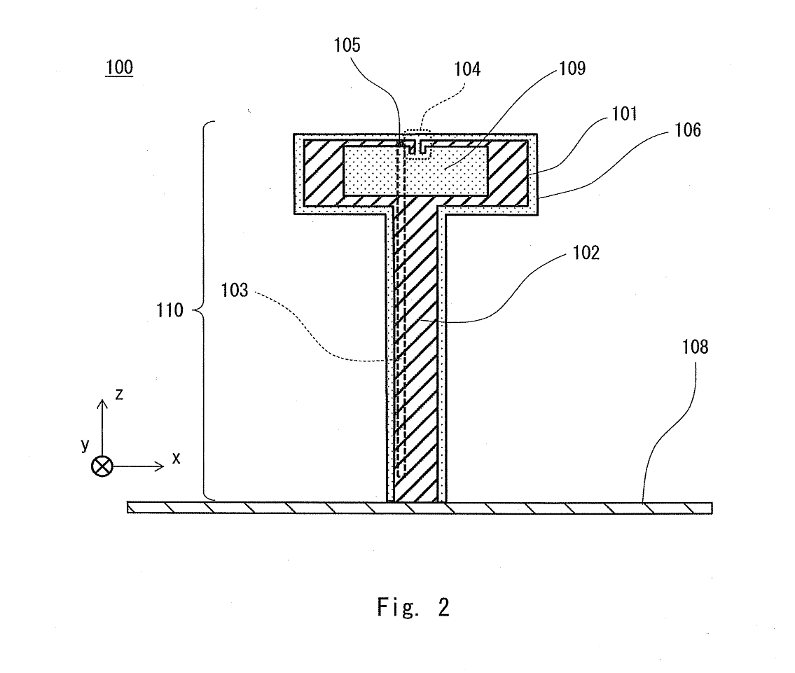

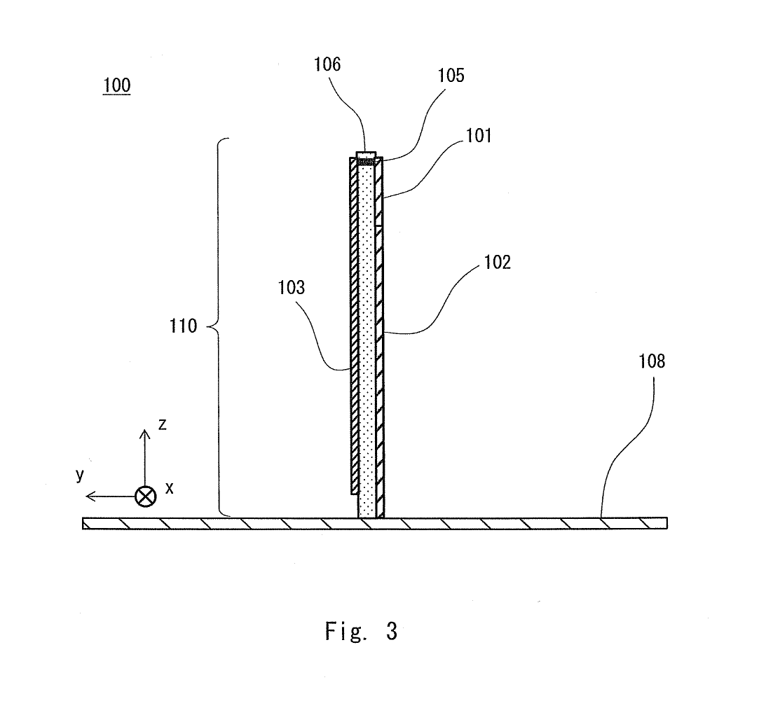

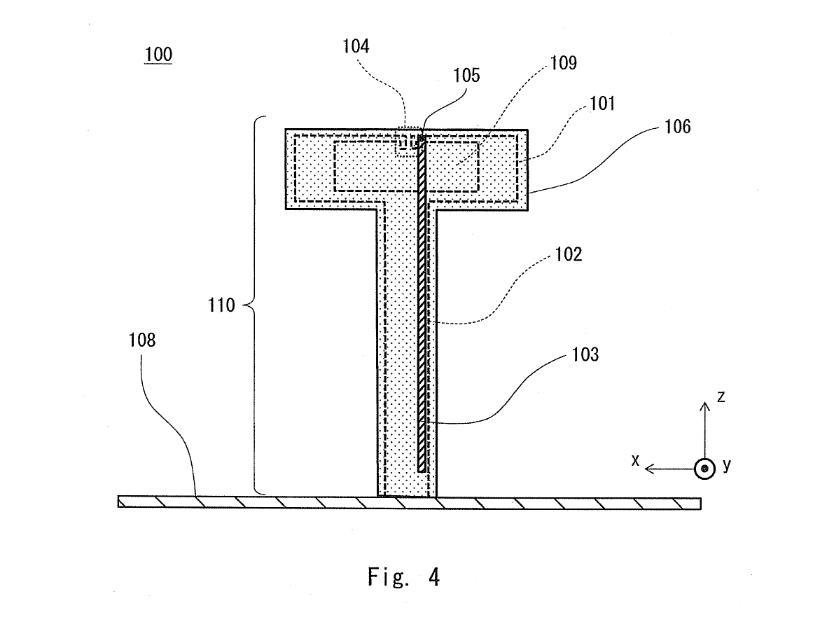

FIG. 1 is a perspective view showing one example of an antenna 100 according to a first exemplary embodiment of the present invention. FIGS. 2, 3, and 4 are plan views of the antenna 100 shown in FIG. 1 when it is seen from a y-axis negative direction, an x-axis negative direction, and a y-axis positive direction, respectively.

The antenna 100 includes an antenna element 110 arranged substantially in parallel with the xz-plane and a conductive reflector 108 arranged substantially in parallel with the xy-plane.

The antenna element 110 includes a dielectric substrate 106, a split-ring part 101 and a connection part 102 arranged on the front layer of the dielectric substrate 106 (front surface on the side of the y-axis negative direction), a feed line 103 arranged on the rear layer of the dielectric substrate 106 (front surface on the side of the y-axis positive direction), and a conductor via 105 that connects different layers of the dielectric substrate 106.

The split-ring part 101 is a substantially C-shaped conductor in which a part of the periphery of a rectangular ring having a longer side in the x-axis direction is cut by a split part 104. The split part 104 is provided near the center of the longer side of the split-ring part 101 which is far from the reflector 108 (side of the z-axis positive direction).

The connection part 102 is a conductor that extends in the z-axis direction, and has one end that is connected to a part near the center of the longer side of the split-ring part 101 which is close to the reflector 108 (on the side of the z-axis negative direction) and the other end that is connected to the reflector 108. The connection part 102 electrically connects the split-ring part 101 and the reflector 108.

The feed line 103 is a linear conductor and has one end that is connected to a part on the long side of the split-ring part 101 which is far from the reflector 108 (on the side of the z-axis positive direction) via the conductor via 105. The feed line 103 spans the opening 109 of the split-ring part 101 when it is seen from the y-axis direction and extends to an area that is opposed to the connection part 102. That is, the feed line 103 overlaps with an area surrounded by the edges of the connection part 102 when seen from the y-axis direction. The other end of the feed line 103 is connected to an RF circuit (high-frequency circuit) (not shown).

While the split-ring part 101, the connection part 102, and the feed line 103 that compose the antenna element 110 are typically formed of copper foil, they may be formed of another conductive material. They may be formed of the same material or may be formed of materials different from one another.

The dielectric substrate 106 that supports each conductor element of the antenna element 110 may be formed of any material and by any process. The dielectric substrate 106 may be, for example, a printed board using a glass epoxy resin, an interposer substrate such as a Large Scale Integration (LSI), a module substrate using a ceramic material such a Low Temperature Co-fired Ceramics (LTCC), or may of course be a semiconductor substrate such as silicon.

Here, the case in which the antenna element 110 is formed on the dielectric substrate 106 has been described as an example. However, as long as the respective components formed of a conductor are arranged and connected as stated above, it is not required for the space between the respective components to necessarily be filled with a dielectric material. For example, a structure in which the respective components are manufactured from sheet metal and the interval between the respective components is partially supported by a dielectric material support member can also be employed. In this case, the sections other than the dielectric material support member are hollow, and hence the dielectric loss can be further reduced compared to the case in which the dielectric material substrate 106 is used and the radiation efficiency of the antenna 100 can be improved.

Further, although the reflector 108 is typically formed of a sheet metal or a copper foil bonded to the dielectric substrate, it may be formed of any other conductive material.

Further, although the conductor via 105 is typically formed by plating a through-hole that is formed in the dielectric substrate 106 by a drill, it may be of any structure as long as the layers can be electrically connected. The conductor via 105 may also be configured using, for example, a laser via formed by a laser, a copper line or the like.

Next, functions and effects according to this exemplary embodiment will be described.

By using the antenna 100 according to this exemplary embodiment, the split-ring part 101 serves as an LC series resonant circuit (split-ring resonator) in which an inductance generated by an electric current flowing along a ring and a capacitance generated between conductors opposed to each other in the split part 104 are connected to each other in series. A large current flows through the split-ring part 101 near the resonance frequency of the split-ring resonator and a part of the current components contribute to the radiation, whereby the antenna 100 operates as an antenna.

By using the antenna 100 according to this exemplary embodiment, which uses LC resonance in the split-ring resonator, in contrast to the dipole antenna and the patch antenna that use a wavelength resonance, it is possible to reduce the size of the antenna compared to those of conventional antennas.

Furthermore, the present inventors have found that among the current components that flow through the split-ring part 101, current components in the x-axis direction are the components that mainly contribute to radiation. Therefore, in the antenna 100 according to this exemplary embodiment, the split-ring part 101 is formed into a rectangle which is long in the x-axis direction, whereby it is possible to achieve excellent radiation efficiency.

Furthermore, the present inventors have found, as a result of a detailed study of the electrical field distribution of the split-ring part 101 in the resonance mode according to this exemplary embodiment, that a virtual ground plane is formed on the plane that includes the part near the center of the split-ring part 101 in the x-axis direction and is perpendicular to the x axis.

Accordingly, in the antenna 100 according to this exemplary embodiment, the connection part 102 is connected to the part near the center of the split-ring part 101 in the x-axis direction so that the connection part 102 is positioned near the virtual ground plane, whereby it is possible to electrically connect the split-ring part 101 and the reflector 108 without greatly changing the radiation pattern and the radiation efficiency.

The feed line 103 is capacitatively coupled to the connection part 102 and forms a transmission line in an area that is opposed to the connection part 102. As a result, an RF signal generated by the RF circuit (not shown) is transmitted by the feed line 103 and is supplied to the split-ring part 101.

Since a part of electromagnetic waves radiated from the split-ring part 101 is reflected by the reflector 108, the antenna 100 according to this exemplary embodiment has a radiation pattern having directivity in the z-axis positive direction. It is therefore possible to efficiently radiate the electromagnetic waves in a specific direction.

The resonance frequency of the split-ring resonator can be made low by increasing the inductance by making the size of the ring of the split-ring part 101 larger and making the current path longer, or by increasing the capacitance by narrowing the space between the conductors opposed to each other in the split part 104.

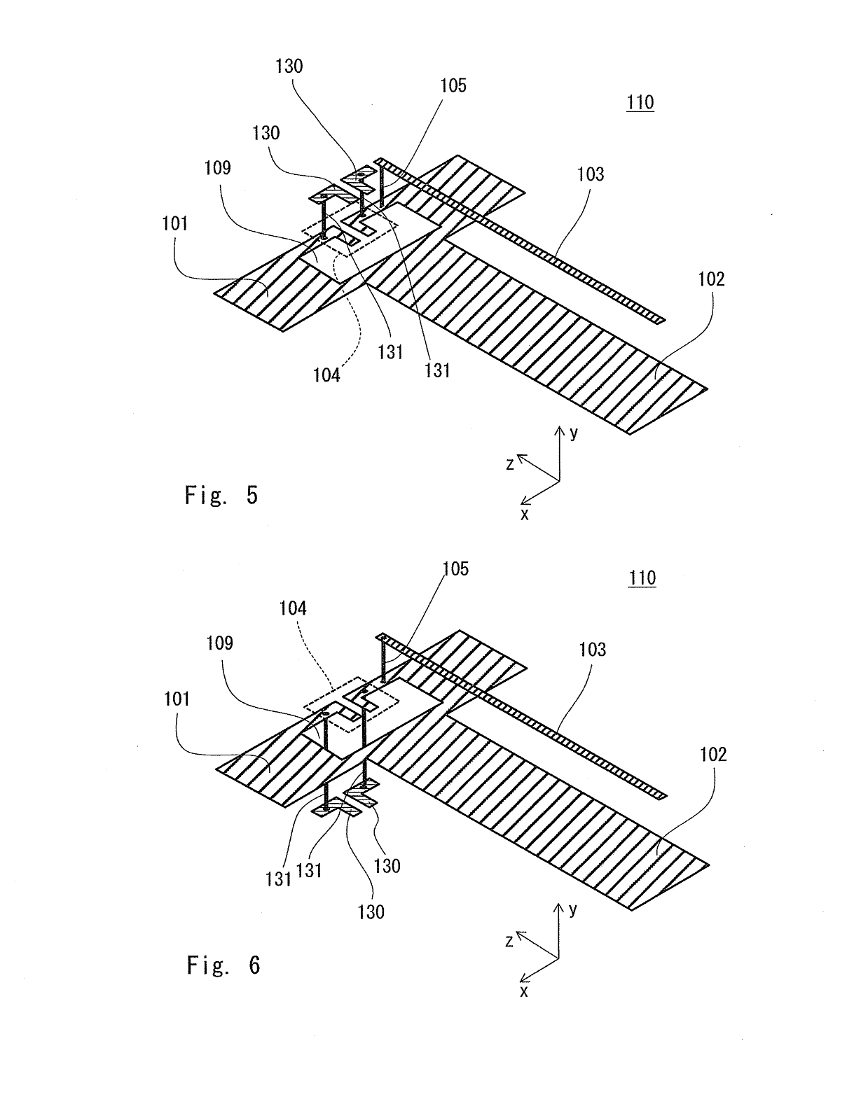

One possible method to increase the capacitance is, for example, as shown in FIGS. 5 and 6, to employ a structure in which auxiliary conductor patterns 130 are provided in a layer of the dielectric substrate 106 different from the layer in which the split-ring part 101 is arranged and the auxiliary conductor patterns 130 are electrically connected to the split part 104 by conductor vias 131. The area of the conductors that are opposed to each other in the split part 104 increases due to the arrangement of the auxiliary conductor patterns 130, whereby it is possible to increase the capacitance without increasing the size of the resonator as a whole. FIG. 5 shows an example in which the auxiliary conductor patterns 130 are arranged on a layer the same as the layer on which the feed line 103 is arranged. FIG. 6 shows a case in which the auxiliary conductor patterns 130 are arranged on a layer different from the layer on which the split-ring part 101 is arranged and the layer on which the feed line 103 is arranged.

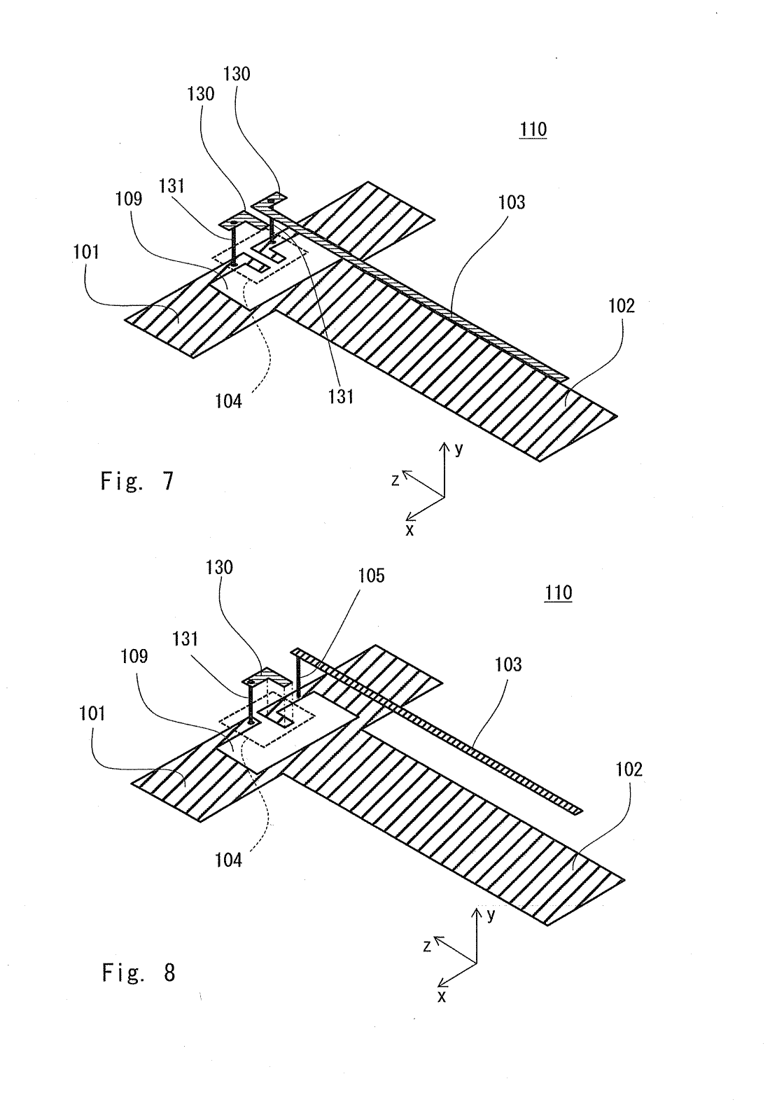

Further, as shown in FIG. 7, such a structure in which the feed line 103 is directly connected to the auxiliary conductor pattern 130 in the structure shown in FIG. 5 may be employed. It is therefore possible to omit the conductor via 105 and to simplify the structure.

Further, as shown in FIG. 8, a structure in which the auxiliary conductor pattern 130 is provided in one conductor of the split part 104 and the auxiliary conductor pattern 130 and at least a part of the other conductor of the split part 104 overlap each other when seen from the y-axis positive direction may be employed. It is therefore possible to further increase the area of the conductors that are opposed to each other, whereby it is possible to increase the capacitance without increasing the size of the resonator as a whole.

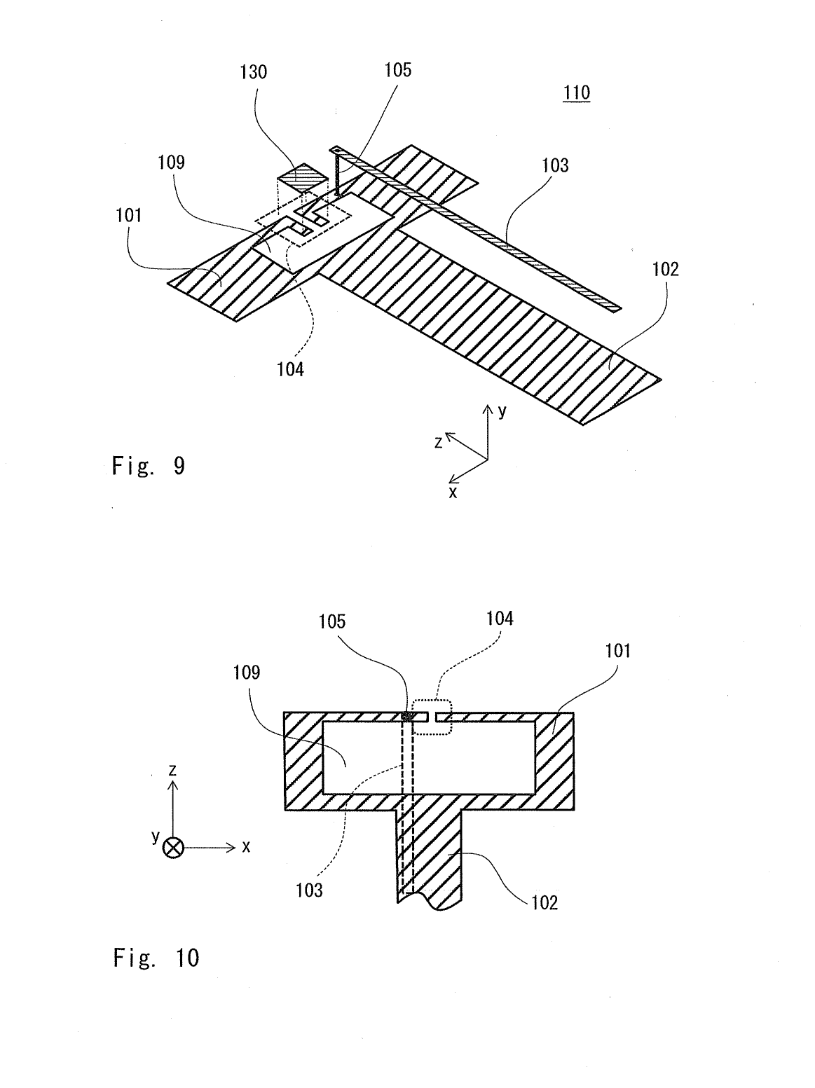

Further, as shown in FIG. 9, a structure in which the conductor vias 131 are not provided and both conductors of the auxiliary conductor pattern 130 and the split part 104 overlap each other when seen from the y-axis positive direction may be employed. It is therefore possible to further increase the area of the conductors that are opposed to each other, whereby it is possible to increase the capacitance without increasing the size of the resonator as a whole.

Further, as shown in FIG. 10, it may be possible to decrease the capacitance by decreasing the area of the conductors that are opposed to each other in the split part 104. According to this structure, it is possible to make the resonance frequency of the split-ring resonator be high.

The split-ring part 101 preferably has a longer side in the x-axis direction in order to obtain excellent radiation efficiency as stated above. While the case in which the split-ring part 101 is a rectangle has been described as a representative example, the split-ring part 101 may have another shape as long as it has a longer side in the x-axis direction. Even when the split-ring part 101 has a shape other than a rectangle, this does not change the essential effect of the present invention. The split-ring part 101 may have, for example, an elliptical shape or a bow tie shape.

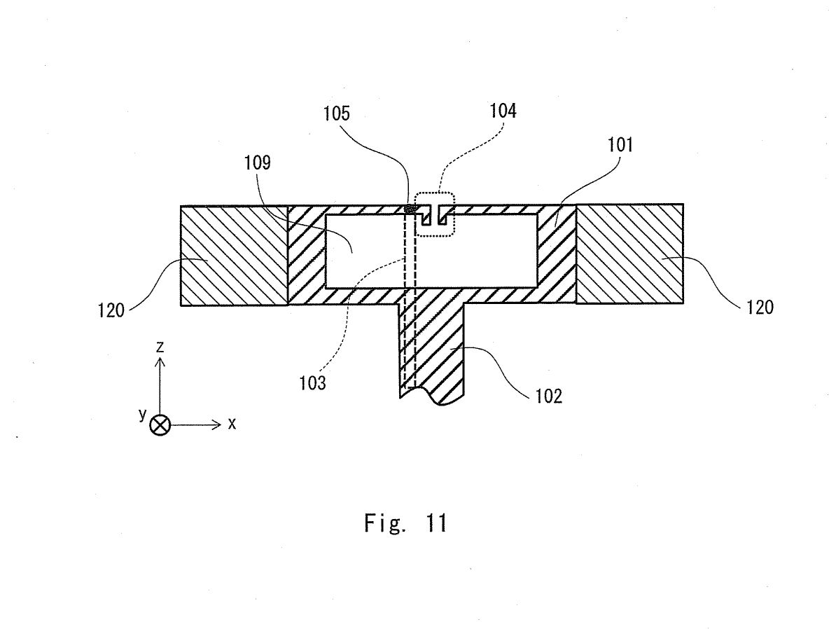

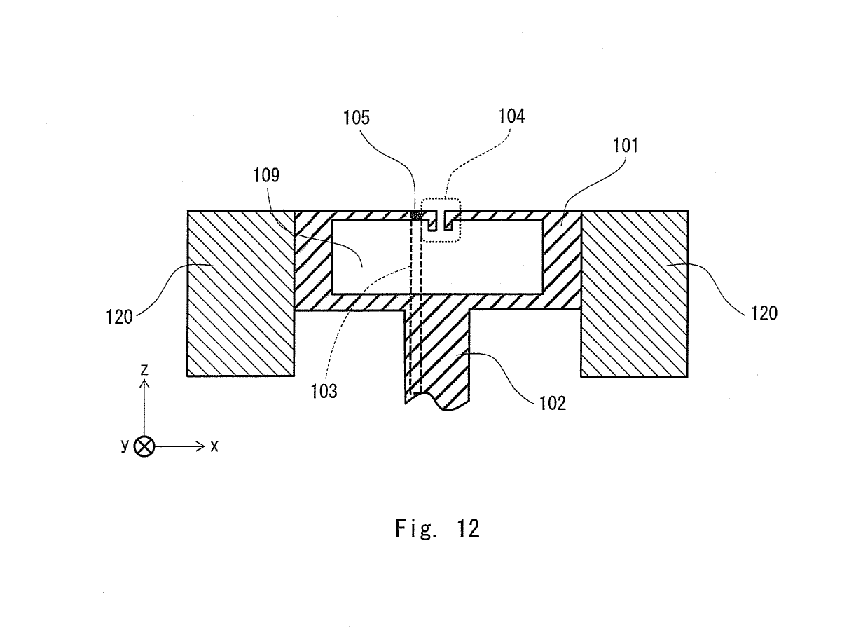

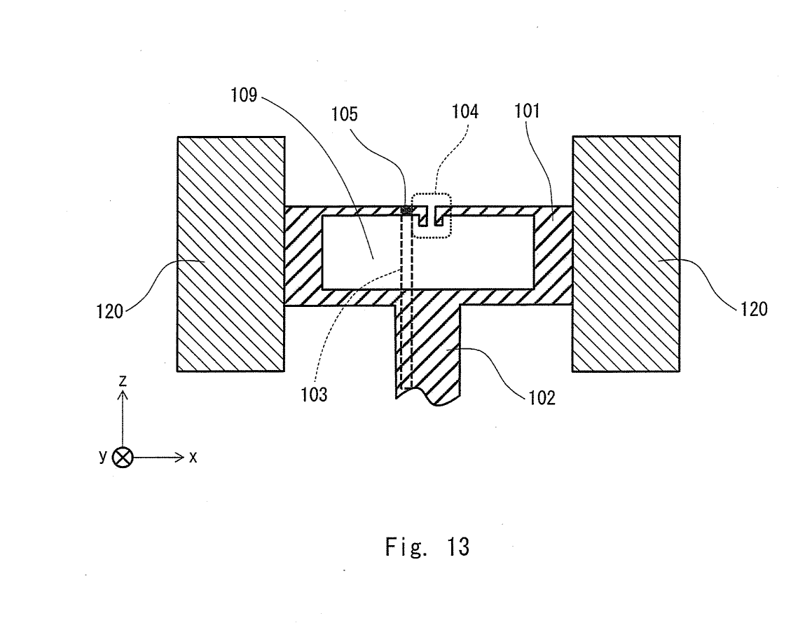

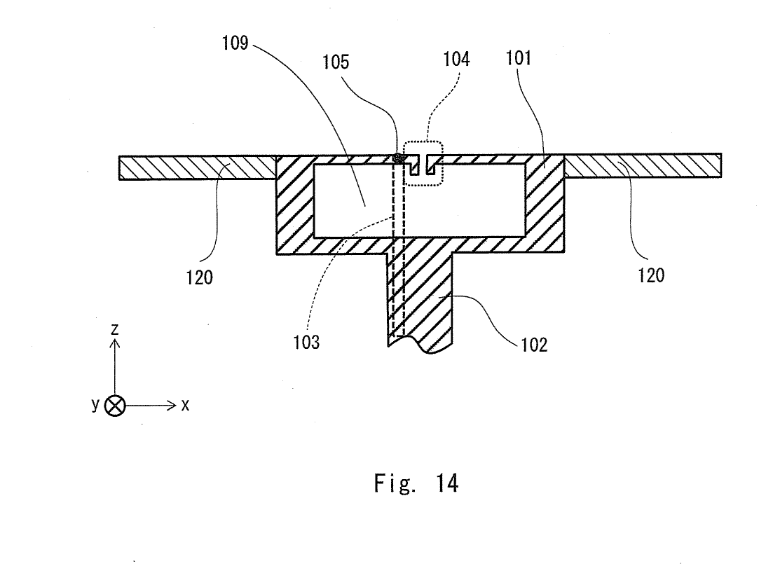

Further, as shown in FIG. 11, a structure in which conductive radiation parts 120 are included on the respective ends of the split-ring part 101 in the x-axis direction may be employed. According to this structure, it is possible to induce the current components in the x-axis direction that contribute to radiation to radiation parts 120, whereby it is possible to improve the radiation efficiency. While the case in which the size of the radiation part 120 in the z-axis direction and the size of the split-ring part 101 in the z-axis direction coincide with each other has been shown in FIG. 11, the shape of the radiation part 120 is not limited to this. As shown in FIGS. 12 and 13, for example, a structure in which the size of the radiation part 120 in the z-axis direction is larger than the size of the split-ring part 101 in the z-axis direction may be employed. Alternatively, as shown in FIG. 14, a structure in which the size of the radiation part 120 in the z-axis direction is smaller than the size of the split-ring part 101 in the z-axis direction may be employed.

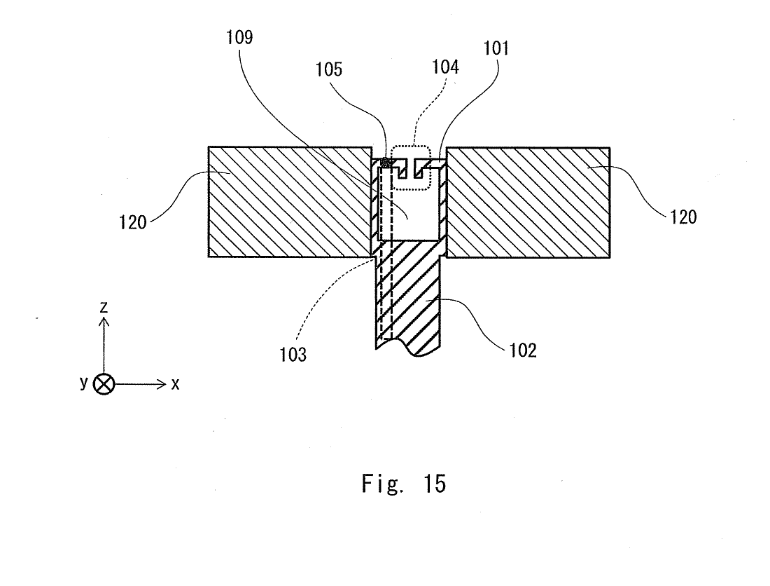

In the structure including the radiation parts 120, it is sufficient that the part which includes the split-ring part 101 and the radiation parts 120 have a longer side in the x-axis direction. Therefore, the split-ring part 101 does not necessarily have a longer side in the x-axis direction. As shown in FIG. 15, for example, the shape of the split-ring part 101 may be a rectangle having a longer side in the z-axis direction or may be a square, a circle, or a triangle.

Further, since the characteristic impedance of the transmission line composed of the feed line 103 and the connection part 102 can be designed by the width of the feed line 103 or the layer spacing between the feed line 103 and the connection part 102, by matching the characteristic impedance of the transmission line with the impedance of the RF circuit, it becomes possible to supply the signal of the RF circuit to the antenna without reflections, and hence this is preferable. However, even in a case where the characteristic impedance of the transmission, line is not matched with the impedance of the RF circuit, this does not change the essential effect of the present invention.

Further, in the antenna element 110 according to this exemplary embodiment, the impedances of the feed line 103 and the split-ring resonator can be matched by changing the connection position between the feed line 103 and the split-ring part 101.

Further, as described above, the connection part 102 is preferably arranged near the virtual ground plane formed on a plane which includes a part near the center of the split-ring part 101 in the x-axis direction and is perpendicular with the x axis along the virtual ground plane. More specifically, the range of one quarter of the length of the split-ring part 101 in the x-axis direction or the length of the part including the split-ring part 101 and the radiation parts 120 in the x-axis direction extending in the x-axis positive direction or the x-axis negative direction from the virtual ground plane can be substantially regarded to be a ground surface. The connection part 102 is preferably located in this area.

Therefore, the length of the connection part 102 in the x-axis direction is preferably equal to or smaller than half of the length of the split-ring part 101 in the x-axis direction or half of the length of the part including the split-ring part 101 and the radiation parts 120 in the x-axis direction. However, even when the connection part 102 is located in an area other than the one stated above, this does not change the essential effect of the present invention. Further, even when the length of the connection part 102 in the x-axis direction is in a range other than the one stated above, this does not change the essential effect of the present invention.

Further, the split-ring part 101 and the reflector 108 are preferably arranged in such a way that they are separated from each other by about one quarter of the wavelength in the z-axis direction. It is therefore preferable that the length of the connection part 102 in the z-axis direction be about one quarter of the wavelength. In this case, the electromagnetic waves radiated from the split-ring part 101 in the z-axis positive direction and the electromagnetic waves radiated in the z-axis negative direction and reflected by the reflector 108 strengthen each other, whereby it is possible to improve the antenna gain in the z-axis positive direction. However, even when the z-direction distance between the split-ring part 101 and the reflector 108 has a value other than one quarter of the wavelength, this does not change the essential effect of the present invention.

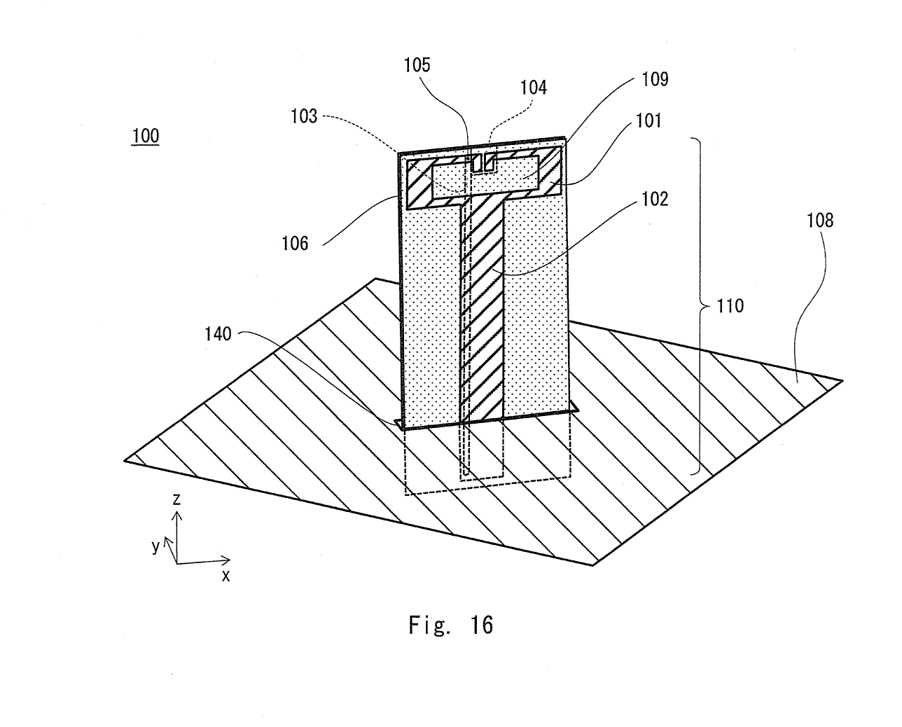

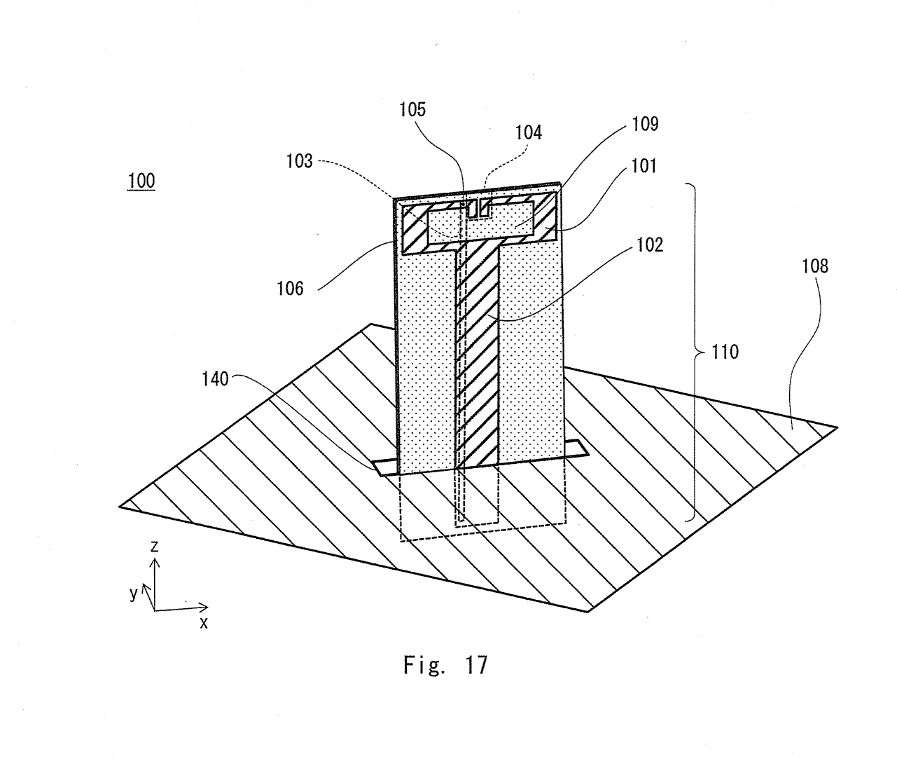

Further, as shown in FIG. 16, a structure in which a through-hole 140 is provided in the reflector 108, the antenna element 110 is inserted into the through-hole 140, and the antenna element 110 penetrates through the reflector 108 may be considered. In this case, the feed line 103 can be extended to the z-axis negative direction side of the reflector 108, which results in an advantage that the RF circuit (not shown) included on the side of the z-axis negative direction of the reflector 108 and the feed line 103 can be easily connected to each other.

Further, as shown in FIG. 17, a structure in which the connection part 102 and the reflector 108 are not electrically connected to each other by making the size of the through-hole 140 larger than that of the cross section of the antenna element 110 on the xy-plane may be employed.

While the structure in which the reflector 108 is provided in the antenna 100 has been described as an example, the reflector 108 may be omitted. In such a case, the electromagnetic waves are radiated in broader directions, whereby it is possible to efficiently form a broader communication area.

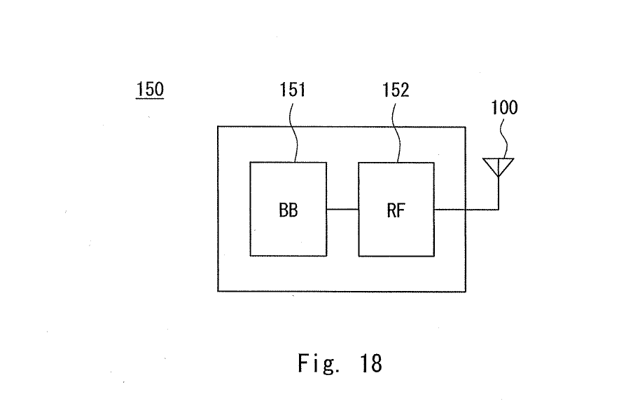

FIG. 18 shows a configuration example of a radio communication apparatus 150 including the antenna 100 according to this exemplary embodiment. The radio communication apparatus 150 includes a baseband circuit 151 that performs signal processing and an RF circuit part 152 that generates an RF signal and is able to perform radio communication by transmitting or receiving the RF signal by the antenna 100. However, the structure of the radio communication apparatus 150 is not limited to the one shown in FIG. 18. The radio communication apparatus 150 may have a structure, for example, in which a plurality of antennas 100, RF circuits 152, and baseband circuits 151 are provided or may have a structure in which a part of the baseband circuit is provided outside the radio communication apparatus 150 and the radio communication apparatus 150 and the part of the baseband circuit provided outside the radio communication apparatus 150 are connected to each other by a cable.

### Second Exemplary Embodiment

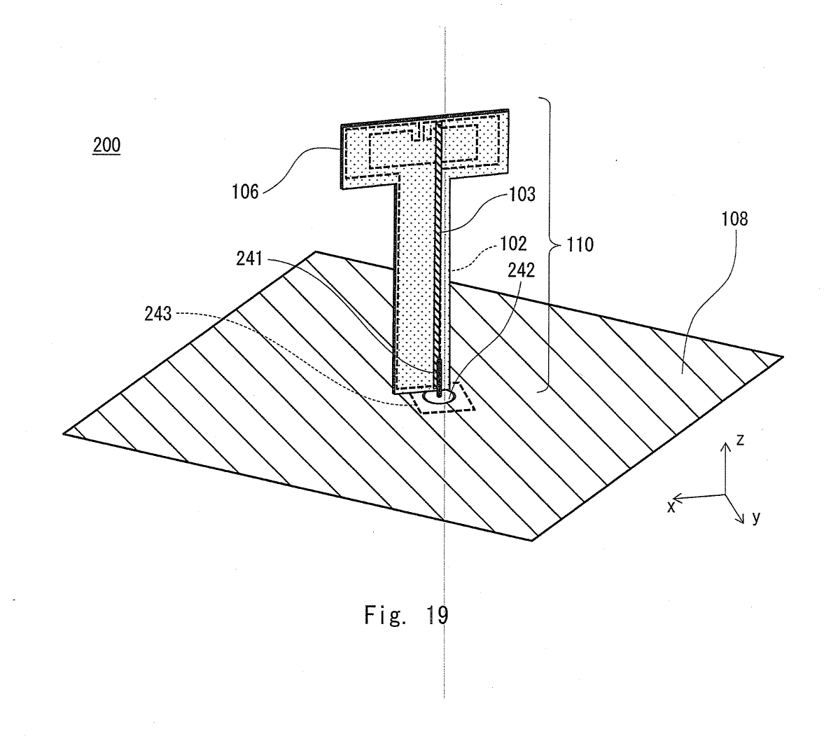

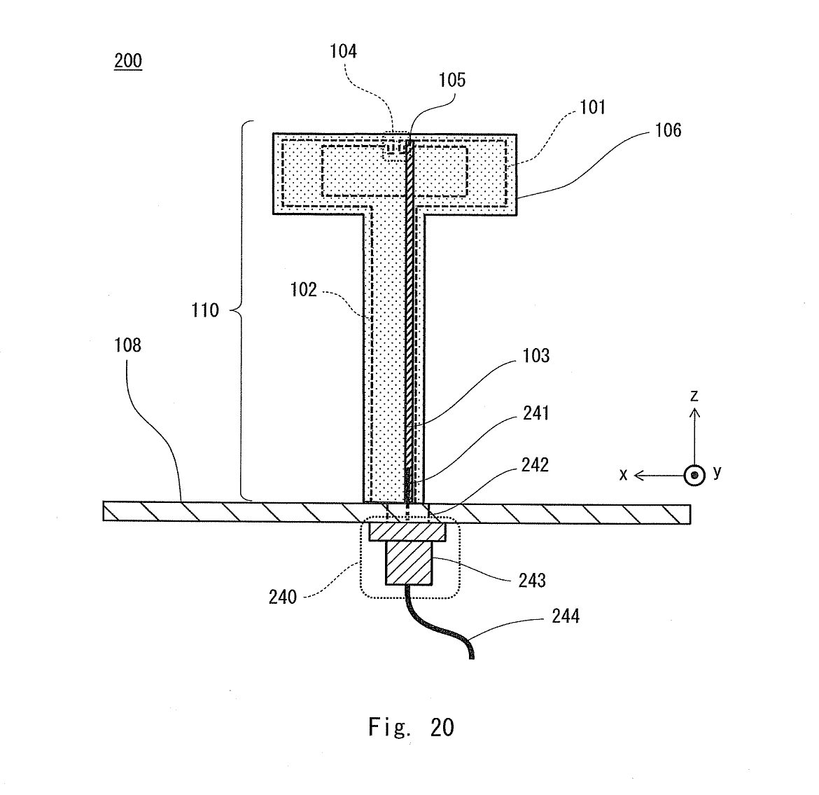

FIG. 19 is a perspective view of an antenna 200 according to a second exemplary embodiment of the present invention. FIG. 20 is a plan view of the antenna 200 according to the second exemplary embodiment when it is seen from the y-axis positive direction. As shown in FIGS. 19 and 20, the antenna 200 according to this exemplary embodiment is the same as the antenna according to the first exemplary embodiment except for the following point.

In the antenna 200 shown in FIGS. 19 and 20, a connector 240 is provided on the rear side (on the side of the z-axis negative direction) of the reflector 108. An external conductor 243 of the connector 240 is electrically connected to the reflector 108. A core wire 241 of the connector 240 passes a clearance 242 provided in the reflector 108, penetrates through the reflector 108 and protrudes from the front side of the reflector 108 (side of the z-axis positive direction), and is electrically connected to the feed line 103 of the antenna element 110.

According to the above structure, the antenna 200 according to this exemplary embodiment is able to supply power to the antenna element 110 on the front side of the reflector 108 via a cable 244 and the connector 240 from the RF circuit, a digital circuit and the like arranged on the rear side of the reflector 108, whereby it is possible to configure the radio communication apparatus without significantly changing the radiation pattern and the radiation efficiency.

### Third Exemplary Embodiment

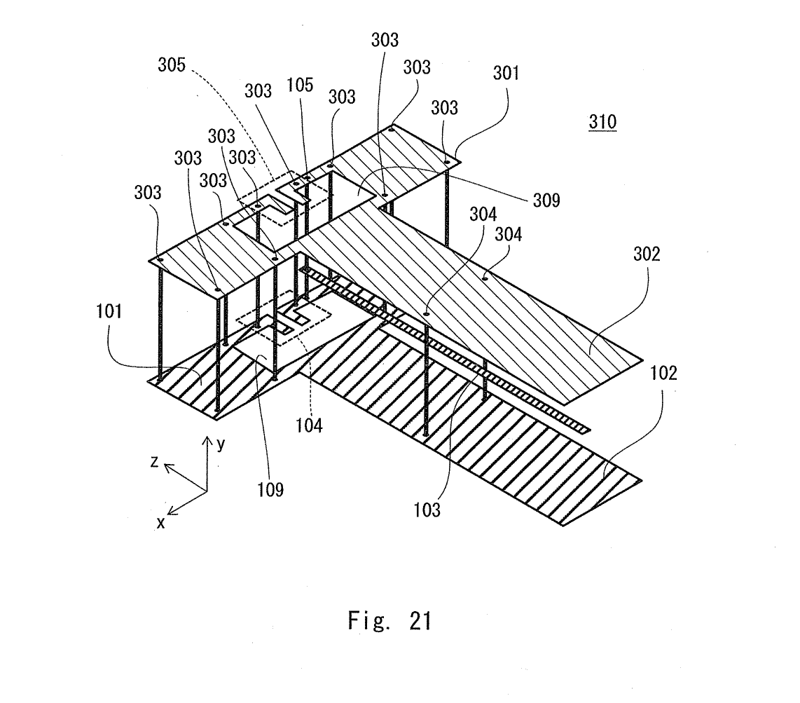

FIG. 21 is a perspective view of an antenna element 310 according to a third exemplary embodiment of the present invention. As shown in FIG. 21, the antenna element 310 according to this exemplary embodiment is the same as the antenna element 110 according to the first exemplary embodiment except for the following point.

The antenna element 310 shown in FIG. 21 includes a second split-ring part 301 and a second connection part 302 in a layer that is different from the layer in which the split-ring part (first split-ring part) 101 and the connection part (first connection part) 102 of the dielectric substrate 106 are arranged and is different from the layer in which the feed line 103 is arranged. The feed line 103 is arranged between the first split-ring part 101 and the first connection part 102, and the second split-ring part 301 and the second connection part 302.

The second connection part 302 is a conductor that extends in the z-axis direction and has one end that is connected to a part near the center of the longer side of the second split-ring part 301 that is close to the reflector 108 (on the side of the z-axis negative direction) and the other end that is connected to the reflector 108. The second connection part 302 electrically connects the second split-ring part 301 and the reflector 108. The first split-ring part 101 and the second split-ring part 301 are electrically connected to each other via a plurality of conductor vias 303 and operate as one split-ring resonator. Further, the first connection part 102 and the second connection part 302 are electrically connected to each other via a plurality of conductor vias 304.

The feed line 103 has one end that is connected to parts on the longer sides of the first split-ring part 101 and the second split-ring part 301 that are far from the reflector 108 (sides of the z-axis positive direction) via the conductor via 105. The feed line 103 spans the opening 109 of the first split-ring part 101 and the opening 309 of the second split-ring part 301 when it is seen from the y-axis direction and extends to an area that is opposed to the first connection part 102 and the second connection part 302.

The feed line 103 is capacitatively coupled to the first connection part 102 and the second connection part 302 and forms the transmission line in an area that is opposed to the first connection part 102 and the second connection part 302. As a result, the RF signal generated by the RF circuit (not shown) is transmitted by the feed line 103 and is supplied to the first split-ring part 101 and the second split-ring part 301.

By using the antenna element 310 according to this exemplary embodiment, the electromagnetic waves transmitted by the feed line 103 can be confined by the first connection part 102 and the second connection part 302, whereby it is possible to reduce unnecessary radiations from the feed line 103.

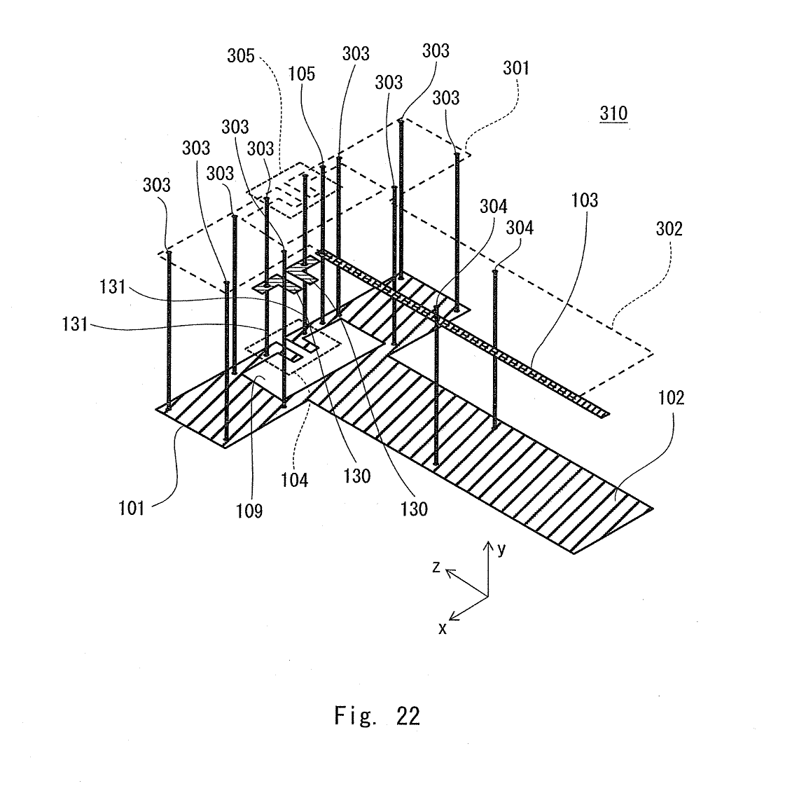

Further, as shown in FIG. 22, similar to FIG. 5 according to the first exemplary embodiment, such a structure in which the auxiliary conductor patterns 130 are provided in a layer different from the layer where the first split-ring part 101 of the dielectric substrate 106 and the second split-ring part 301 are formed and the auxiliary conductor patterns 130 are connected to the split part (first split part) 104 and a second split part 305 via the conductor via 131 may be employed. The area of the conductors that are opposed to each other in the first split part 104 and the second split part 305 increases due to the arrangement of the auxiliary conductor patterns 130, whereby it is possible to increase the capacitance without increasing the size of the resonator as a whole.

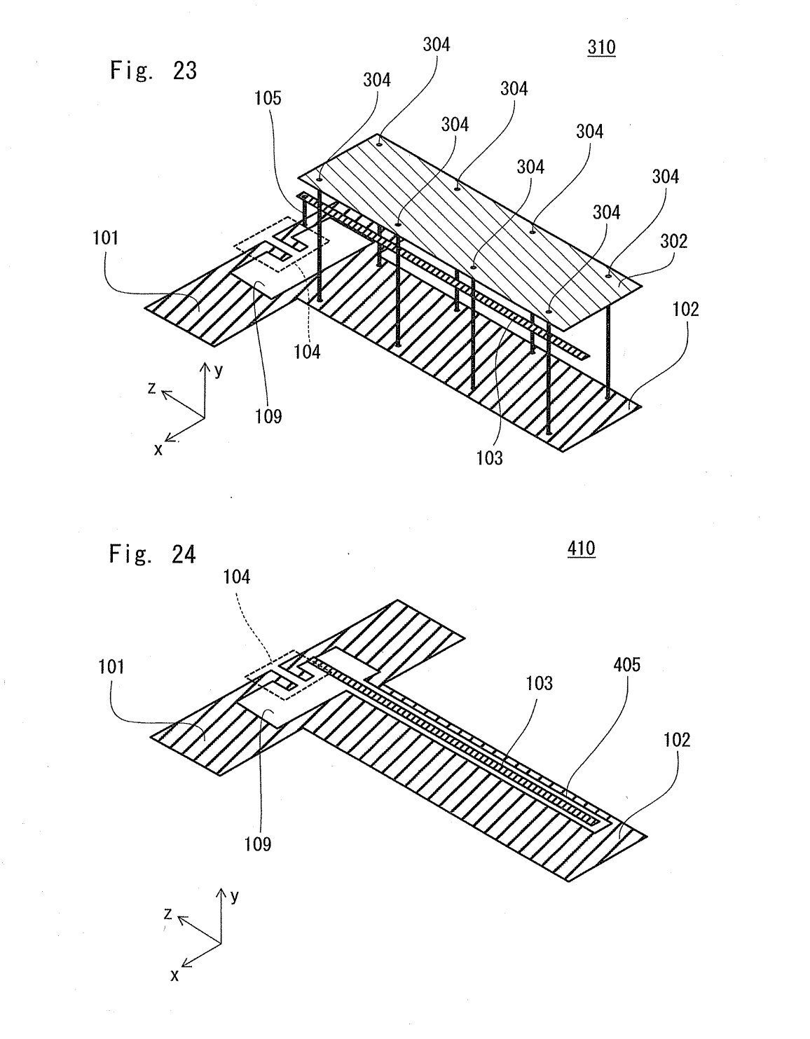

While the structure in which both the second split-ring part 301 and the second connection part 302 are provided has been shown in FIGS. 21 and 22, such a structure in which only one of them is provided may be naturally employed. As shown in FIG. 23, for example, when a structure in which only the second connection part 302 is provided is employed, similar to the structures shown in FIGS. 21 and 22, the electromagnetic waves transmitted by the feed line 103 can be confined by the first connection part 102 and the second connection part 302, whereby it is possible to reduce unnecessary radiations from the feed line 103.

### Fourth Exemplary Embodiment

FIG. 24 is a perspective view of an antenna element 410 according to a fourth exemplary embodiment of the present invention. As shown in FIG. 24, the antenna element 410 according to this exemplary embodiment is the same as the antenna element according to the first exemplary embodiment except for the following point.

In the antenna element 410 shown in FIG. 24, the split-ring part 101, the connection part 102, and the feed line 103 are formed on one layer of the dielectric substrate 106. In this case, one end of the feed line 103 is connected to a part on the longer side of the split-ring part 101 which is far from the reflector 108 (side of the z-axis positive direction) and the other end thereof extends inside a clearance 405 provided in the split-ring part 101 and the connection part 102 and is connected to an RF circuit (not shown).

The feed line 103 is capacitatively coupled to the connection part 102 to thereby form a transmission line in an area that is opposed to the connection part 102. As a result, the RF signal generated by the RF circuit (not shown) is transmitted by the feed line 103 and is supplied to the split-ring part 101.

The antenna element 410 according to this exemplary embodiment can be operated in a way similar to the antenna element 110 according to the first exemplary embodiment.

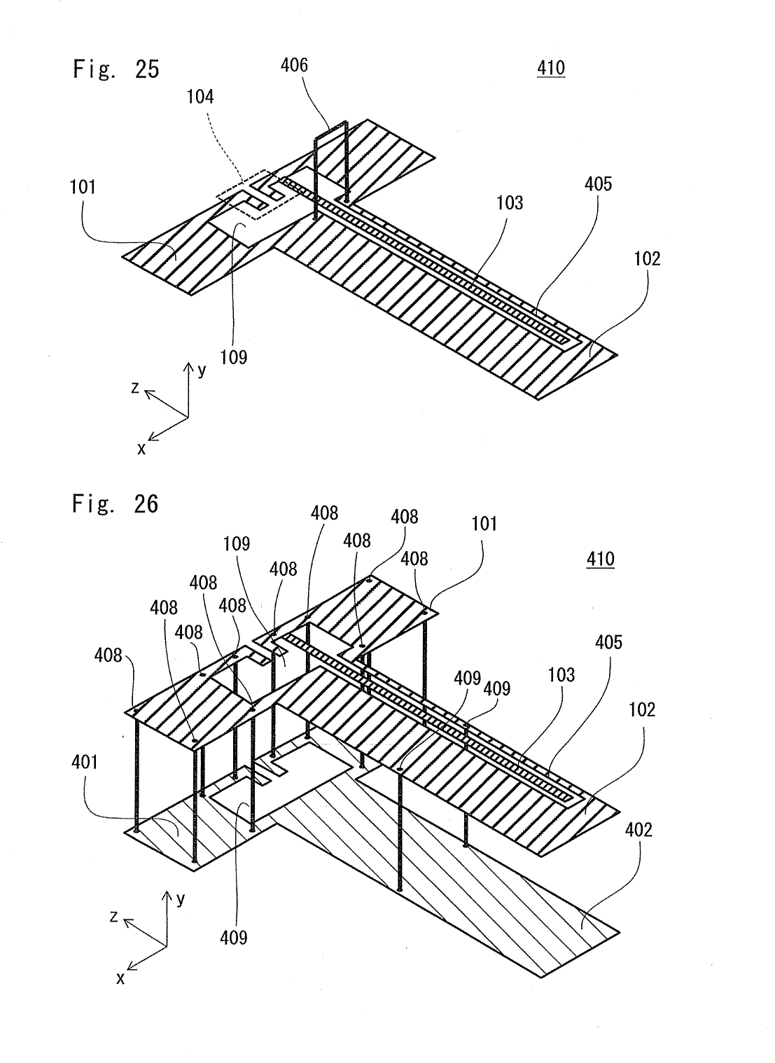

Further, as shown in FIG. 25, such a structure in which a bridge conductor 406 that spans the clearance 405 and electrically connects both ends of the split-ring part 101 separated by the clearance 405 may be employed. According to this structure, it is possible to further stabilize the operation of the antenna element 410.

Further, as shown in FIG. 26, such a structure in which a second split-ring part 401 and a second connection part 402 are included in a layer different from the layer in which the split-ring part (first split-ring part) 101, the connection part (first connection part) 102, and the feed line 103 of the dielectric substrate 106 are arranged may be employed. Similar to the third exemplary embodiment, the first split-ring part 101 and the second split-ring part 401 are electrically connected to each other using a plurality of conductor vias 408 and serve as one split-ring resonator. Further, the first connection part 102 and the second connection part 402 are electrically connected to each other using a plurality of conductor vias 409. According to this structure, the antenna element 410 according to the fourth exemplary embodiment can be operated in a way similar to the antenna element 310 according to the third exemplary embodiment.

### Fifth Exemplary Embodiment

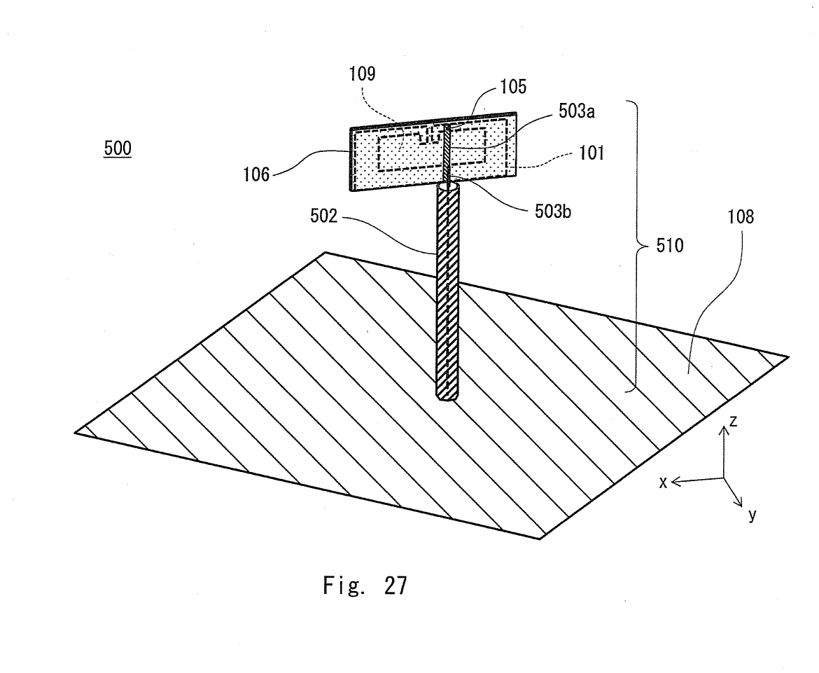

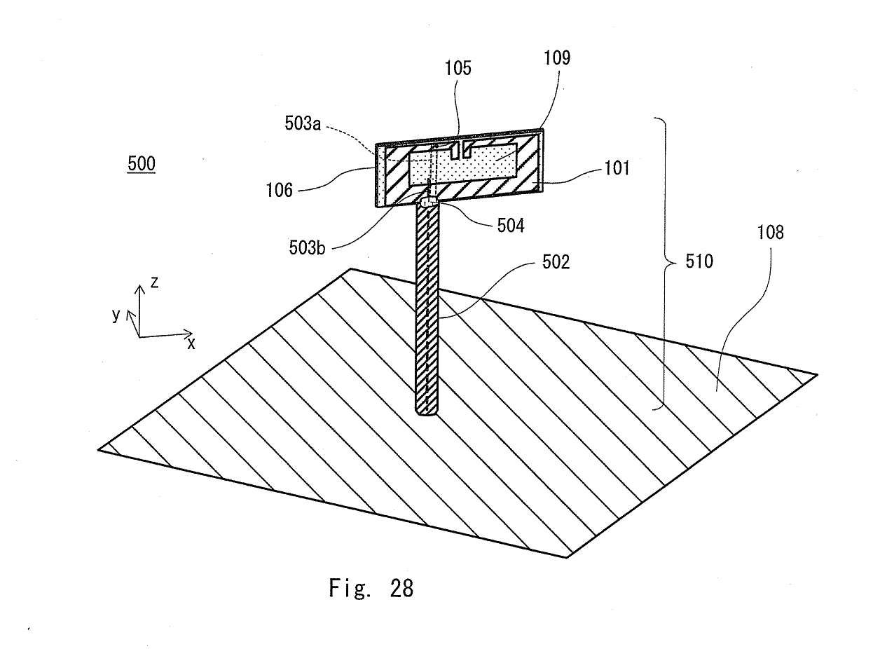

FIGS. 27 and 28 are perspective views of an antenna 500 according to a fifth exemplary embodiment of the present invention when the antenna 500 is seen from directions different from each other. As shown in FIGS. 27 and 28, the antenna 500 according to this exemplary embodiment is similar to the antenna according to the first exemplary embodiment except for the following points.

The antenna 500 shown in FIG. 27 uses an external conductor 502 of a coaxial cable as the connection part that electrically connects the split-ring part 101 and the reflector 108. The external conductor 502 extends in the z-axis direction and has one end that is electrically connected to an area near the center of the longer side of the split-ring part 101 which is on the side close to the reflector 108 (side of the z-axis negative direction) by a solder 504 and the other end that is connected to the reflector 108. The external conductor 502 electrically connects the split-ring part 101 and the reflector 108.

The feed line 503a is a linear conductor and has one end connected to a part on the longer side of the split-ring part 101 which is on the side far from the reflector 108 (side of the z-axis positive direction) via the conductor via 105. The feed line 503a spans the opening 109 of the split-ring part 101 when it is seen from the y-axis direction and is connected to a core wire 503b of the coaxial cable. The other end of the core wire 503b is connected to an RF circuit (not shown). According to this structure, the feed line 503a and the core wire 503b are able to operate in a way similar to the feed line 103 according to the first exemplary embodiment, and the RF signal generated by the RF circuit may be supplied to the split-ring part 101.

While the structure in which the external conductor 502 and the split-ring part 101 are electrically connected to each other by the solder 504 has been described as one example, any connection method may be employed as long as the external conductor 502 and the split-ring part 101 are electrically connected to each other.

By using the antenna 500 according to this exemplary embodiment, the electromagnetic waves transmitted by the core wire 503b can be confined by the external conductor 502, whereby it is possible to reduce unnecessary radiations from the core wire 503b.

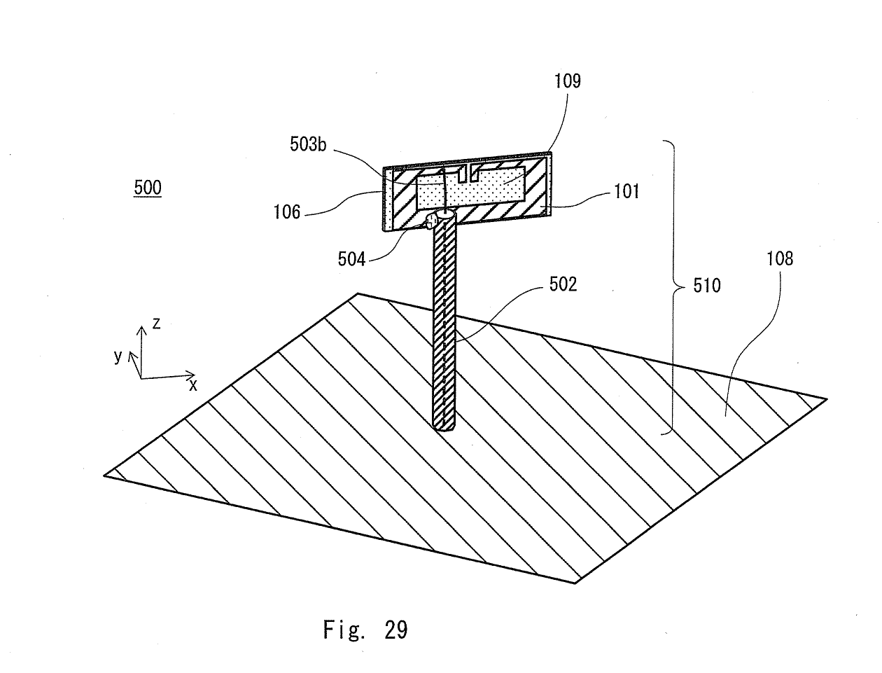

Further, as shown in FIG. 29, such a structure in which the core wire 503b is directly connected to a part on the longer side of the split-ring part 101 which is far from the reflector 108 (side of the z-axis positive direction) without using the feed line 503a may be employed.

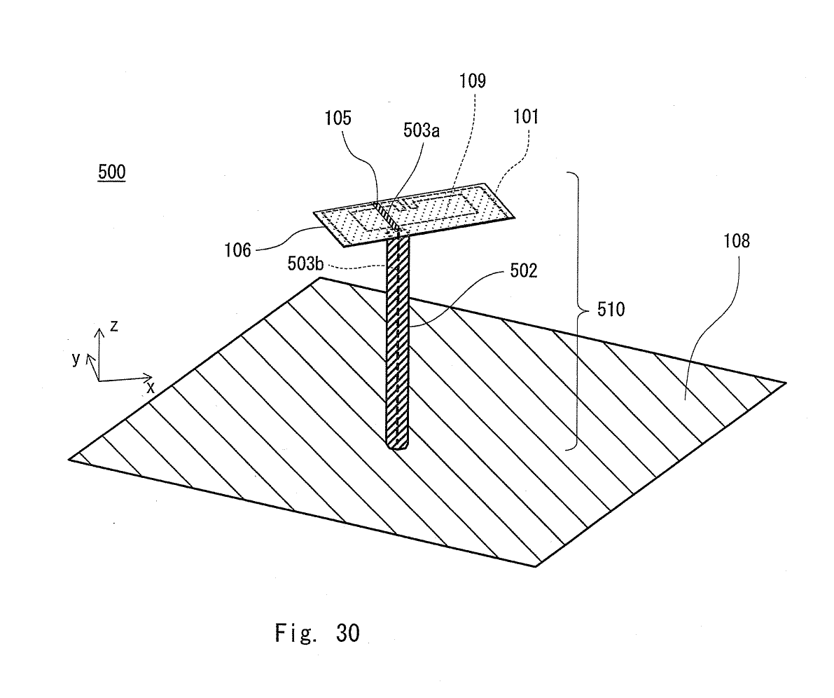

Further, as shown in FIG. 30, such a structure in which the dielectric substrate 106 including the split-ring part 101, the feed line 503a, and the conductor via 105 is arranged in parallel with the xy-plane may be employed.

### Sixth Exemplary Embodiment

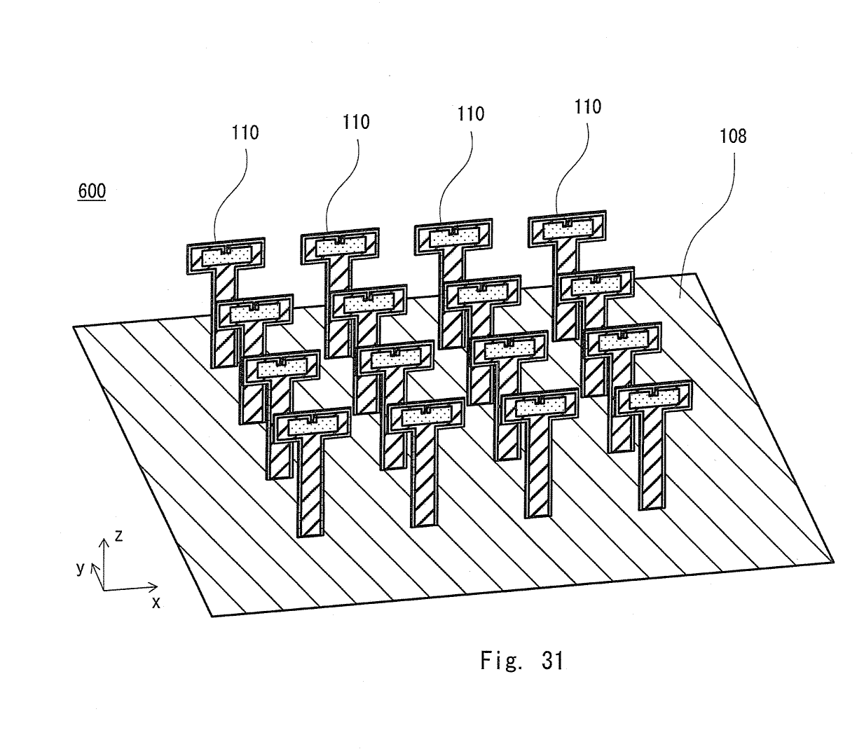

FIG. 31 is a perspective view of an array antenna 600 according to a sixth exemplary embodiment of the present invention. As shown in FIG. 31, the array antenna 600 according to this exemplary embodiment is based on the first exemplary embodiment and includes a plurality of antenna elements 110 according to the first exemplary embodiment.

The array antenna 600 according to this exemplary embodiment has a structure in which the antenna elements 110 according to the first exemplary embodiment are arranged in one-dimensional or two-dimensional arrays at constant intervals on one reflector 108. The connection parts 102 of the respective antenna elements 110 are electrically connected to the reflector 108 and the respective feed lines 103 are connected to an RF circuit (not shown).

According to the array antenna 600 according to this exemplary embodiment, by inputting RF signals whose phases are different from one another to the respective antenna elements 110, beam forming can be performed in a desired direction.

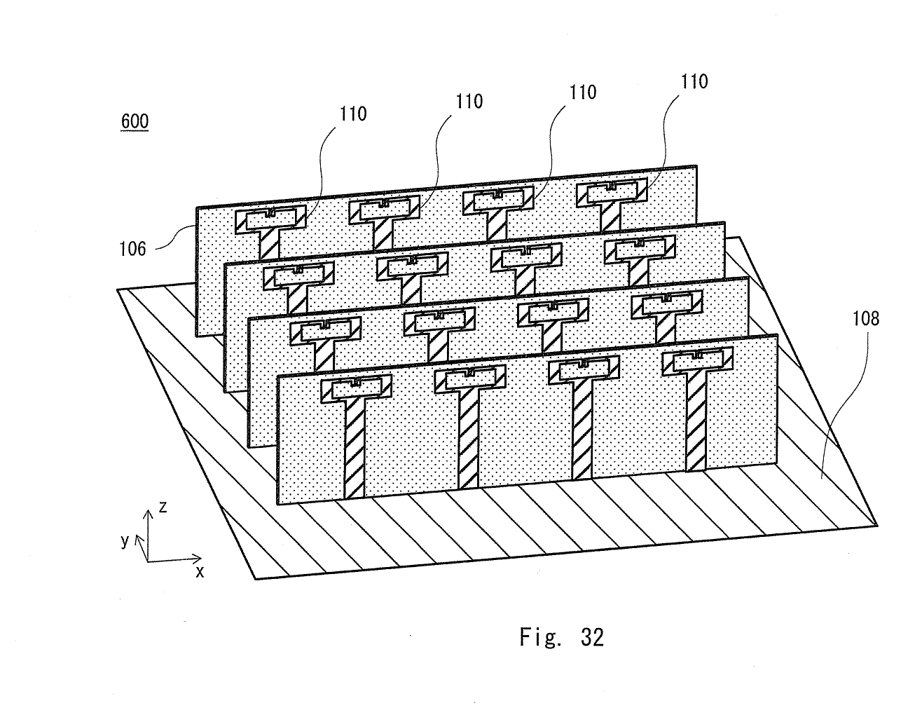

Further, as shown in FIG. 32, a structure in which a plurality of antenna elements 110 that compose the array antenna 600 are arranged in one dielectric substrate 106 for each line may be employed. According to such a structure, the number of processes for aligning the antenna elements 110 can be reduced, whereby it is possible to easily assemble the array antenna 600.

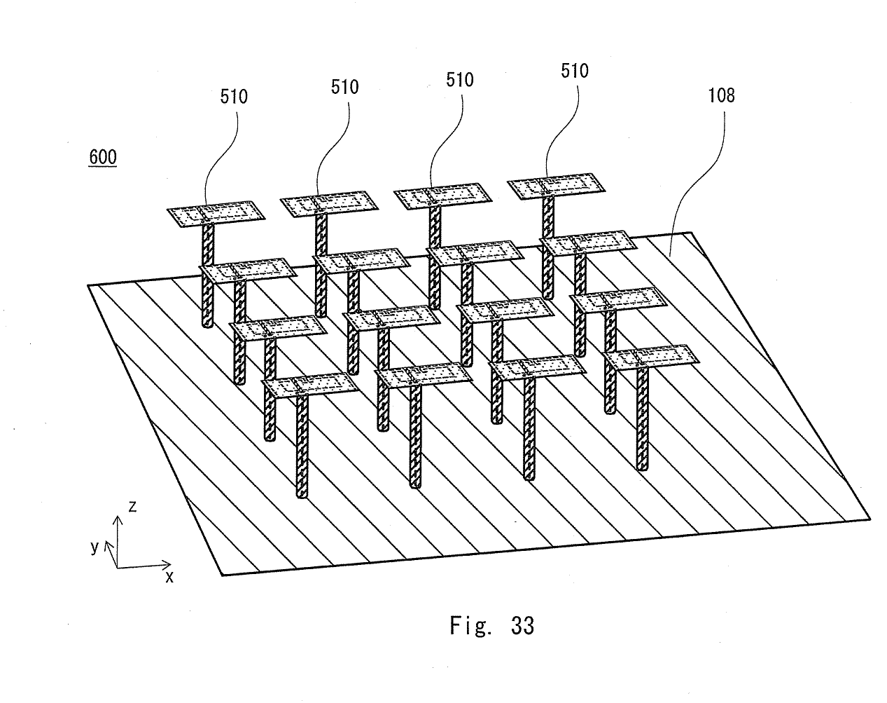

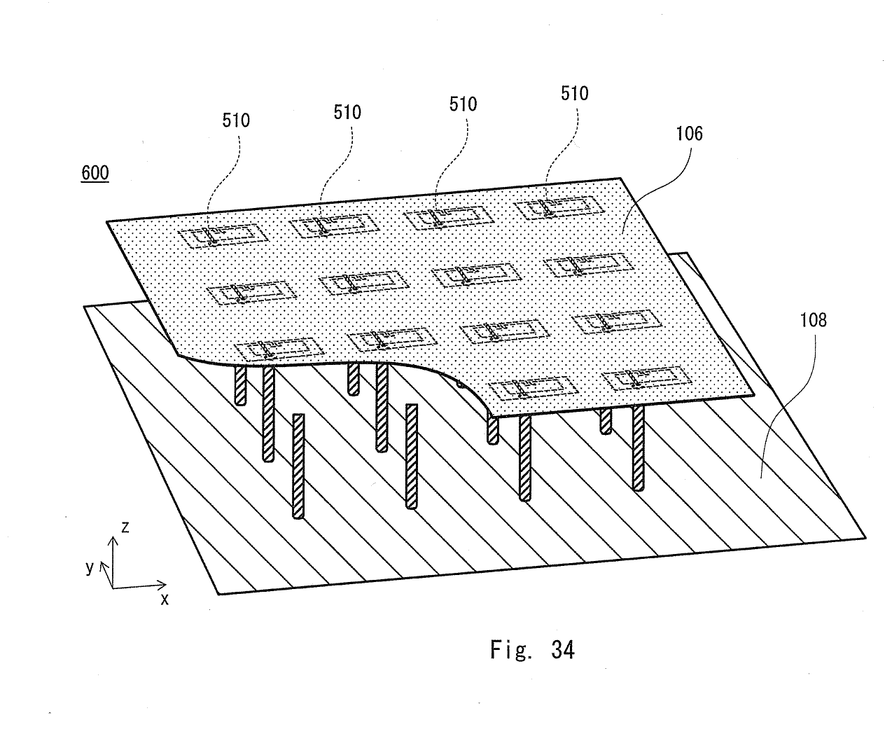

While the example based on the first exemplary embodiment has been described here, a configuration based on the other exemplary embodiments can of course also be employed. As shown in FIG. 33, for example, antenna elements 510 according to the fifth exemplary embodiment may be arranged in array. Further, as shown in FIG. 34, a plurality of split-ring parts 101 may be arranged in one dielectric substrate 106. According to such a structure, the number of processes for aligning the antenna elements 510 can be reduced, whereby it is possible to easily assemble the array antenna 600.

Naturally, the foregoing exemplary embodiments and the plurality of modified examples can be combined within a scope in which the contents thereof do not conflict with one another. Furthermore, in the foregoing exemplary embodiments and the modified examples, the functions and the like of the respective components have been described in detail. The functions thereof may be changed to any type within a scope that satisfies the present invention.

While the present invention has been described with reference to the exemplary embodiments, the present invention is not limited to the above exemplary embodiments. Various changes that can be understood by those skilled in the art may be made on the configuration and the details of the present invention within the scope of the present invention.

This application is based upon and claims the benefit of priority from Japanese Patent Application No. 2014-73196, filed on Mar. 31, 2014, the disclosure of which is incorporated herein in its entirety by reference.

### REFERENCE SIGNS LIST

100 ANTENNA
101 SPLIT-RING PART (FIRST SPLIT-RING PART)
102 CONNECTION PART (FIRST CONNECTION PART)
103 FEED LINE
104 SPLIT PART (FIRST SPLIT PART)
105 CONDUCTOR VIA
106 DIELECTRIC SUBSTRATE
108 REFLECTOR
109 OPENING
110 ANTENNA ELEMENT
120 RADIATION PART
130 AUXILIARY CONDUCTOR PATTERN
131 CONDUCTOR VIA
150 RADIO COMMUNICATION APPARATUS
151 BASEBAND CIRCUIT
152 RF CIRCUIT PART
200 ANTENNA
240 CONNECTOR
241 CORE WIRE
242 CLEARANCE
243 EXTERNAL CONDUCTOR
244 CABLE
301 SECOND SPLIT-RING PART
302 SECOND CONNECTION PART
303, 304 CONDUCTOR VIA
305 SECOND SPLIT PART
309 OPENING
310 ANTENNA ELEMENT
401 SECOND SPLIT-RING PART
402 SECOND CONNECTION PART
405 CLEARANCE
406 BRIDGE CONDUCTOR
408, 409 CONDUCTOR VIA
410 ANTENNA ELEMENT
500 ANTENNA
502 EXTERNAL CONDUCTOR
503a FEED LINE
503b CORE WIRE
600 ARRAY ANTENNA

1. An antenna comprising:
an antenna element; and
a reflector conductor, wherein:
the antenna element comprises:
a first split-ring conductor having such a shape that a part of a ring is cut by a split part;
a first connection conductor having one end that is electrically connected to the first split-ring conductor and another end that is electrically connected to the reflector conductor; and
a feed line conductor having one end that is electrically connected to the first split-ring conductor, and
the feed line conductor spans an opening that is formed inside the first split-ring conductor and overlaps an area surrounded by an outer edge of the first connection conductor.

2. The antenna according to claim 1, wherein:
the first split-ring conductor has such a shape that it includes a plurality of longitudinal sides in a direction that is parallel to the surface of the reflector conductor in which the antenna element is arranged,
the split part is provided in an area near the center of a first longitudinal side of the first split-ring conductor, and
the first connection conductor is electrically connected to an area near the center of a second longitudinal side of the first split-ring conductor.

3. The antenna according to claim 1, comprising a radiation conductor that is electrically connected to the first split-ring conductor to extend the length of the first split-ring conductor in the direction that is parallel to the surface of the reflector conductor in which the antenna element is arranged.

4. The antenna according to claim 1, wherein at least the first split-ring conductor, the first connection conductor, and the feed line conductor are arranged on a layer provided in a dielectric substrate.

5. The antenna according to claim 4, wherein:
the first split-ring conductor and the first connection conductor are arranged in one layer of the dielectric substrate,
the feed line conductor is arranged in another layer of the dielectric substrate, spans the opening of the first split-ring conductor, and extends to be opposed to the first connection conductor, and
one end of the feed line conductor and the first split-ring conductor are electrically connected to each other via a conductor via.

6. The antenna according to claim 4, wherein:
the first split-ring conductor, the first connection conductor, and the feed line conductor are arranged in a layer the same as the layer in which the dielectric substrate is formed, and
a clearance is provided in a position of the first split-ring conductor that corresponds to that of the feed line conductor, and the feed line conductor is arranged inside the clearance.

7. The antenna according to claim 4, wherein:
at least one of a second split-ring conductor and a second connection conductor is further provided on a layer of the dielectric substrate different from the layer where the first split-ring conductor and the first connection conductor are provided, and
at least one of a plurality of conductor vias that electrically connect the first split-ring conductor and the second split-ring conductor and a plurality of conductor vias that electrically connect the first connection conductor and the second connection conductor is included.

8. The antenna according to claim 7, wherein an auxiliary conductor that increases the capacitance is electrically connected to at least one of conductor parts on both sides cut by a split part of the first split-ring conductor or the second split-ring conductor.

9. The antenna according to claim 1, wherein a plurality of antenna elements are arranged in the reflector conductor in one-dimensional arrays or two-dimensional arrays.

10. A radio communication apparatus comprising at least one antenna according to claim 1.
